(19) United States
(12) Patent Application Publication
(10) Pub. No.: US 2026/0313542 A1
(43) Pub. Date: Oct. 8, 2026

(54) COMMUNICATION METHOD, ELECTRONIC DEVICE, AND STORAGE MEDIUM

(71) Applicant: BEIJING XIAOMI MOBILE SOFTWARE CO., LTD., Beijing (CN)

(72) Inventor: Yajun CHENG, Beijing (CN)

(73) Assignee: BEIJING XIAOMI MOBILE SOFTWARE CO., LTD., Beijing (CN)

(21) Appl. No.: 19/484,682

(22) PCT Filed: May 22, 2023
(86) PCT No.: PCT/CN2023/095641

§ 371 Date: Nov. 14, 2025

(51) Int. Cl. H04W 52/02; H04W 28/02; H04W 76/14; H04W 84/12

(52) U.S. Cl. CPC H04W 52/0216; H04W 28/0221; H04W 52/0219; H04W 76/14; H04W 84/12

(57) ABSTRACT

A communication method applied to an access point (AP) includes: determining a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which the traffic type includes a low-latency traffic; and transmitting the first radio frame.

### CROSS-REFERENCE TO RELATED APPLICATION

The present application is a U.S. National Stage of International Application No. PCT/CN2023/095641, filed on May 22, 2023, the content of which is incorporated herein by reference in its entirety for all purposes.

### FIELD

Embodiments of the present disclosure relate to the field of mobile communication technology, and specifically, embodiments of the present disclosure relate to a communication method, an electronic device, and a storage medium.

### BACKGROUND

In the currently studied WiFi technologies, in order to support energy-saving work under large-scale Internet of Things (IOT) devices, a target wake time (TWT) mechanism is proposed; and at the same time, in order to guarantee the transmission of traffics such as low-latency traffics, a restricted-TWT (R-TWT) mechanism is proposed. In order to further reduce the power consumption of Wi-Fi networks, the R-TWT mechanism needs to be improved to ensure the transmission of traffics.

### SUMMARY

In a first aspect, embodiments of the present disclosure provide a communication method applied to an access point (AP), and the method includes: determining a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which the traffic type includes a low-latency traffic; and transmitting first radio frame.

In a second aspect, embodiments of the present disclosure provide a communication method applied to a TDLS device, and the method includes: receiving a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which a traffic type includes a low-latency traffic.

In a third aspect, embodiments of the present disclosure further provide an electronic device including a processor and a memory storing a computer program executable by the processor, in which the processor is configured to determine a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which the traffic type includes a low-latency traffic; and transmit the first radio frame.

In a fourth aspect, embodiments of the present disclosure further provide an electronic device including a processor and a memory storing a computer program executable by the processor, in which the processor executes the program to implement the method according to the second aspect of the present disclosure.

### BRIEF DESCRIPTION OF THE DRAWINGS

To describe technical solutions in embodiments of the present disclosure more clearly, the following briefly introduces the accompanying drawings required for the description of the embodiments of the present disclosure. Apparently, the accompanying drawings described below show some embodiments of the present disclosure, and those skilled in the art can obtain other drawings based on these drawings without paying creative efforts.

FIG. 1 is a first schematic diagram of an embodiment of the present disclosure.

FIG. 2 is a second schematic diagram of an embodiment of the present disclosure.

FIG. 3 is a first flow chart of a communication method provided by an embodiment of the present disclosure.

FIG. 4 is a second flow chart of a communication method provided by an embodiment of the present disclosure.

FIG. 5 is a third flow chart of a communication method provided by an embodiment of the present disclosure.

FIG. 6 is a fourth flow chart of a communication method provided by an embodiment of the present disclosure.

FIG. 7 is a first schematic block diagram of an electronic device provided by an embodiment of the present disclosure.

FIG. 8 is a second schematic block diagram of an electronic device provided by an embodiment of the present disclosure.

FIG. 9 is a third schematic block diagram of an electronic device provided by an embodiment of the present disclosure.

### DETAILED DESCRIPTION OF THE DISCLOSURE

Illustrative embodiments will be illustrated in detail herein, and the examples thereof are illustrated in the accompanying drawings. When the following description refers to the accompanying drawings unless otherwise specified, the same or similar elements are denoted by the same numerals in the different accompanying drawings. Implementations described in the illustrative embodiments do not represent all implementations consistent with the present disclosure. On the contrary, they are merely examples of a device and a method consistent with some aspects of the present disclosure, as elaborated in the appended claims.

The terms used in embodiments of the present disclosure are only for purpose of description of particular embodiments, and are not intended to limit the present disclosure. The singular form “a”, “the” and “this” used in the present disclosure and the appended claims is also intended to include the plural form, unless other meanings are explicitly expressed in the context. It should be understood that, the term “and/or” used herein refers to include any or all of the possible combinations of one or more of listed related items. For example, A and/or B, can mean that A exists alone, A and B exist at the same time, and B exists alone. The character “/” generally indicates that the associated objects before and after it are an “or” relationship. The term “a plurality” refers to two or more, and in view of this, the term “a plurality” may also be understood as “at least two” in embodiments of the present disclosure.

It should be understood that, although the terms “first”, “second”, “third” may be employed by the present disclosure to describe various information, these information should not limited by these terms. These terms are only used to distinguish the information of the same type from each other. For example, a first information may be referred to as a second information without departing from the scope of the present disclosure, and similarly, the second information may also be referred to as the first information. Depending on the context, the word “if” used here may be interpreted as “when . . . ” , “upon . . . ” or “in response to determination”.

Technical solutions in embodiments of the present disclosure will be clearly and completely described below with reference to the accompanying drawings in the embodiments of the present disclosure. It is apparent that the described embodiments are only a part of the embodiments of the present disclosure, and is not the all of them. Based on the embodiments of the present disclosure, all other embodiments obtained by those skilled in the art without paying creative efforts, fall into the protection scope of the present disclosure.

Embodiments of the present disclosure provide a communication method, an electronic device, and a storage medium, to further improve the R-TWT mechanism and ensure transmission of the low-latency traffic.

The method and the apparatus are based on the same disclosure conception, and since the method and the apparatus solve problems on similar principles, the implementation of the apparatus and the method may be referred to each other, and the description is not repeated.

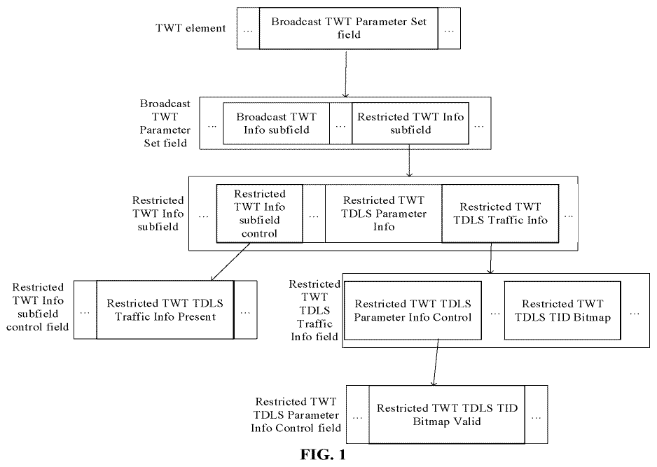

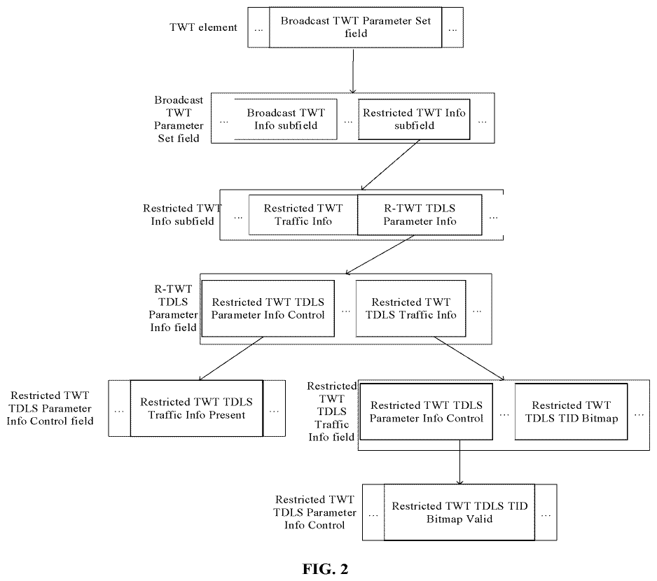

Referring to FIGS. 1 and 2, FIGS. 1 and 2 are structural block diagrams of TWT elements in communication methods provided by embodiments of the present disclosure.

An access point (AP) broadcasts a traffic type allowed to be transmitted between the TDLS devices via a TDLS link within an R-TWT SP (Service Period) of an R-TWT schedule to a tunneled direct link setup (TDLS) device through the first radio frame. The TDLS device negotiates with the AP through the TWT setup frame and becomes a member of a certain R-TWT schedule.

In some examples, the AP is, for example, a device having a wireless-to-wired bridging function, and the AP is responsible for extending the service provided by the wired network to the wireless network. The TDLS device, such as a station (STA), such as an electronic device having a wireless network access function, provides a frame delivery service to allow information to be transmitted.

In some examples, the AP determines and receives a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which a traffic type may include a low-latency traffic or all traffics.

In some examples, FIG. 1 is a partial structural schematic diagram of an optional TWT element. As illustrated in FIG. 1, a broadcast TWT parameter set field of a TWT element in a first radio frame includes a restricted TWT info field;
the restricted TWT info field includes restricted TWT info control information;
the restricted TWT info control information includes a restricted TWT TDLS traffic info present identifier bit;
in a case where the restricted TWT TDLS traffic info present identifier bit is set to the first parameter value, the restricted TWT info field includes a restricted TWT TDLS traffic info field; and
the first identification information is carried in the restricted TWT TDLS traffic info field.

It could be understood that only some contents of the TWT element and various fields and subfields of the TWT element in FIG. 1 are illustrated; taking the TWT element as an example, the TWT element further includes other fields not illustrated in FIG. 1, such as an element ID field, a length control field, a TWT parameter info field, and the like, and other unillustrated contents should also be understood as contents included in the TWT element.

As an example, the first parameter value may be set to 1, that is, in a case where the restricted TWT TDLS traffic info present identifier bit is set to 1, and the restricted TWT info field includes the restricted TWT TDLS traffic info field.

In some examples, FIG. 2 is a partial structural schematic diagram of another optional TWT element. As illustrated in FIG. 2, a broadcast TWT parameter set field of a TWT element in a first radio frame includes a restricted TWT info field;
the restricted TWT info field includes a restricted TWT TDLS parameter info field;
the restricted TWT TDLS parameter info control field of the restricted TWT TDLS parameter info field includes a restricted TWT TDLS traffic info present identifier bit;
in a case where the Restricted TWT TDLS traffic info present identifier bit is set to the second parameter value, the restricted TWT TDLS parameter info field includes a restricted TWT TDLS traffic info field; and
the first identification information is carried in the restricted TWT TDLS traffic info field.

It could be understood that only some contents of the TWT element and various fields and subfields of the TWT element in FIG. 2 are illustrated; taking the TWT element as an example, the TWT element further includes other fields not illustrated in FIG. 2, such as an element ID field, a length control field, a TWT parameter info field, and the like, and other unillustrated contents should also be understood as contents included in the TWT element.

As an example, the second parameter value may be set to 1, that is, in a case where the restricted TWT TDLS traffic info present identifier bit is set to 1, and the restricted TWT TDLS parameter info field includes the restricted TWT TDLS traffic info field.

In some examples, in the partial structure of the TWT element illustrated in FIG. 1 or FIG. 2, the first identification information includes a restricted TWT TDLS traffic identifier (TID) bitmap field in the restricted TWT TDLS traffic info field.

In some examples, the restricted TWT TDLS TID bitmap field may be used to identify a traffic type of a low latency traffic transmitted between the TDLS devices via the TDLS link within the SP of the R-TWT schedule.

In some examples, the restricted TWT TDLS traffic info field further includes a restricted TWT TDLS TID bitmap valid identifier bit;
in which in a case where the restricted TWT TDLS TID bitmap valid identifier bit is set to a third parameter value, within the SP of the R-TWT schedule, the traffic type allowed to be transmitted between the TDLS devices via the TDLS link is the low-latency traffic identified by the first identification information (TWT TDLS TID bitmap field);

As an example, the third parameter value may be set to 1, that is, in a case where the restricted TWT TDLS TID bitmap valid identifier bit is set to 1, the low latency traffic type identified by the restricted TWT TDLS TID bitmap field is valid. The traffic type allowed to be transmitted between the TDLS devices via the TDLS link is the low-latency traffic identified by the TWT TDLS TID bitmap field, within the SP of the R-TWT schedule.

In a case where the restricted TWT TDLS TID bitmap valid identifier bit is set to a fourth parameter value, within the SP of the R-TWT schedule, all traffic types are allowed to be transmitted between the TDLS devices via the TDLS link.

As an example, the fourth parameter value may be set to 0, that is, in a case where the restricted TWT TDLS TID bitmap valid identifier bit is set to 0, the low latency traffic type identified by the restricted TWT TDLS TID bitmap field is invalid. All traffic types are allowed to be transmitted between the TDLS devices via the TDLS link within the service period (SP) of the restricted target wake time (R-TWT) schedule.

In some examples, the restricted TWT TDLS TID bitmap valid identifier bit may be included in a restricted TWT TDLS traffic info control subfield in the restricted TWT TDLS traffic info field.

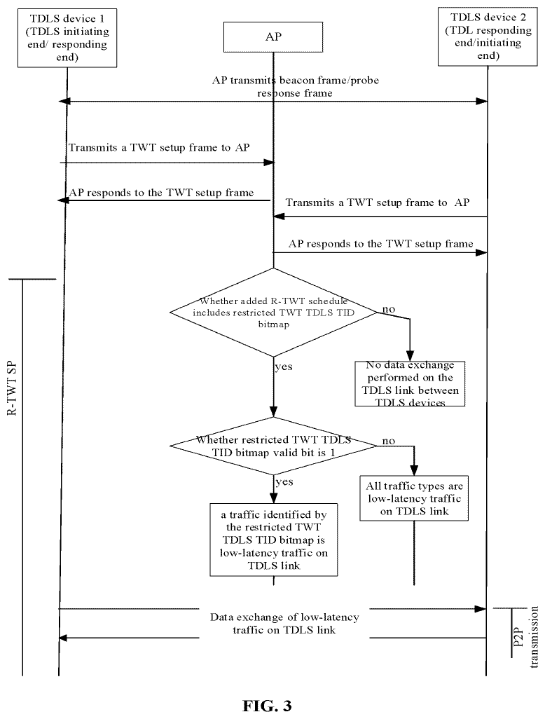

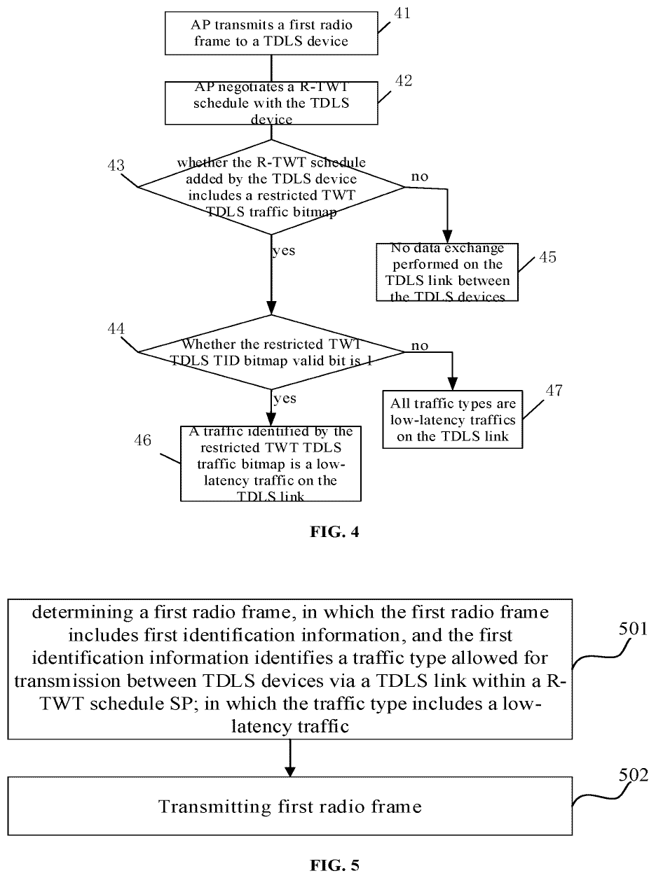

Further, as illustrated in FIGS. 3 and 4, FIGS. 3 and 4 illustrate schematic diagrams of an application scenario and a flow chart of communication methods according to the embodiments of the present disclosure.

The AP transmits a first radio frame to the TDLS device 1 and the TDLS device 2 to broadcast an R-TWT schedule of the low-latency traffic between the TDLS devices via the TDLS link, that is, step 41 in FIG. 4. The first radio frame includes a beacon frame or a probe response frame; and the TWT element is carried in the first radio frame.

In this scenario, the AP negotiates the R-TWT schedule by receiving and responding to the first TWT setup frame transmitted by the TDLS device 1 and the TDLS device 2, which is illustrated in step 42 in FIG. 4.

The TWT request identifier information of the first TWT setup frame indicates that the first TWT setup frame is a TWT setup request; and the first TWT setup frame is a TWT setup request, indicating that the TDLS device (the TDLS device transmitting the first TWT setup frame) requests to become a member of the R-TWT schedule.

As an example, the TWT request identifier information may be 1 or 0. For example, the TWT request identifier information in the first TWT setup frame transmitted by the STA1 or the STA2 to the AP is 1, to indicate a request to become a member of the R-TWT schedule; the TWT request identifier information of 0 in the TWT setup frame responded by the AP indicates that the TWT setup frame is a TWT setup response, and instructs the AP to respond to the TWT setup request transmitted by the TDLS device.

If the TWT element corresponding to the R-TWT schedule joined by the TDLS devices (TDLS device 1 and TDLS device 2) carries a restricted TWT TDLS TID bitmap, the TDLS devices (TDLS device 1 and TDLS device 2) may perform traffic transmission via the TDLS link within the corresponding SP in the R-TWT schedule, that is, as illustrated in step 43 in FIG. 4; otherwise, no data exchange on the TDLS link is performed between the TDLS devices, which is illustrated in step 45 in FIG. 4.

In a case where the TWT element carries a restricted TWT TDLS TID bitmap and traffic transmission may be performed between the TDLS devices via the TDLS link, it is determined whether the restricted TWT TDLS TID bitmap valid identifier bit is 1, that is, as illustrated in step 44 in FIG. 4; If it is 1, within the corresponding service period of the R-TWT schedule, the TDLS devices may transmit the low-latency traffic identified by the restricted TWT TDLS TID bitmap via the TDLS link, that is, as illustrated in step 46 in FIG. 4; otherwise, within the corresponding service period of the R-TWT schedule, data exchange of all traffic types may be performed between the TDLS devices via the TDLS link, that is, as illustrated in step 47 in FIG. 4.

In embodiments of the present disclosure, the R-TWT SP is not only used for low-latency traffic transmission between an R-TWT schedule AP and an R-TWT schedule member STA, but also supports the R-TWT schedule member STAs to perform low-latency traffic transmission via the TDLS link during the TDLS R-TWT duration. Based on the R-TWT mechanism, the periodic target wake time mechanism may effectively guarantee the transmission of a deterministic low-latency traffic and improve the transmission efficiency of a low-latency communication traffic. In addition, based on the TDLS link, communication between STAs without AP is realized. This peer to peer (P2P) communication method does not need to pass through the access point for data transmission, avoids the latency caused by network congestion, reduces the energy consumption of terminal device, and improves the data transmission efficiency. Embodiments of the present disclosure provide a communication method to further improve the R-TWT mechanism and ensure the transmission of the low-latency traffic.

Referring to FIG. 5, embodiments of the present disclosure provide a communication method applied to an access point (AP), and the method includes:
in step 501, a first radio frame is determined, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule,
in which the traffic type includes a low-latency traffic; and
in step 502, the first radio frame is transmitted.

TWT is a technology used to save energy and is designed to further reduce Wi-Fi network power consumption. In some examples, the TWT technology determines the STA sleep and wake time and frequency by causing the STA and the AP to negotiate a service period (SP); and the STA remains active and communicates during this service period, so that it may sleep outside the service period to achieve the purpose of energy saving. In addition, the TWT technology may also enable the AP to provide higher-quality services to a plurality of STAs, minimize contention or overlap, and improve spectral efficiency while reducing Wi-Fi network power consumption.

In a low-latency transmission scenario, the real-time data traffic of many applications has strict latency requirements. For example, the average or maximum latency is of the order of magnitude between a few milliseconds and tens of milliseconds, and the application requires real-time data traffic with minimal jitter and strong reliability. In order to further ensure the communication of the low-latency traffic, based on the TWT technology, a restricted target wake time (R-TWT) is proposed. The R-TWT mechanism allows the AP to provide more predictable latency using enhanced media access protection mechanisms and resource reservation mechanisms to distinguish latency sensitive traffic from other types of traffic, so that the AP reduces worst-case latency and/or reduces jitter and provides more reliable services.

In embodiments of the present disclosure, the AP determines and transmits a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which a traffic type includes a low-latency traffic. In some examples, in embodiments of the present disclosure, the first radio frame includes a beacon frame or a probe response frame.

In some examples, in embodiments of the present disclosure, a broadcast TWT parameter set field of the TWT element in the first radio frame includes a restricted TWT info field;
the restricted TWT info field includes restricted TWT info control information;
the restricted TWT info control information includes a restricted TWT TDLS traffic info present identifier bit;
the restricted TWT info field includes a restricted TWT TDLS traffic info field; and the first identification information is carried in the restricted TWT TDLS traffic info field.

In some examples, in embodiments of the present disclosure, the restricted TWT TDLS traffic info present identifier bit is set to a first parameter value, and the first parameter value indicates that the restricted TWT info field includes the restricted TWT TDLS traffic info field.

In some examples, the restricted TWT TDLS traffic info present identifier bit is included in the TWT element of the first radio frame.

As an example, the first parameter value may be set to 1, that is, in a case where the restricted TWT TDLS traffic info present identifier bit is set to 1, the restricted TWT info field includes the restricted TWT TDLS traffic info field.

In some examples, in embodiments of the present disclosure, a broadcast TWT parameter set field of the TWT element in the first radio frame includes a restricted TWT info field;
the restricted TWT info field includes a restricted TWT TDLS parameter info field;
the restricted TWT TDLS parameter info control field of the restricted TWT TDLS parameter info field includes a restricted TWT TDLS traffic info present identifier bit;
the restricted TWT TDLS parameter info field includes a restricted TWT TDLS traffic info field; and
the first identification information is carried in the restricted TWT TDLS traffic info field.

In some examples, in embodiments of the present disclosure, the restricted TWT TDLS traffic info present identifier bit is set to a second parameter value, and the second parameter value indicates that the restricted TWT TDLS parameter info field includes the restricted TWT TDLS traffic info field.

In some examples, the restricted TWT TDLS traffic info present identifier bit is included in the TWT element of the first radio frame.

As an example, the second parameter value may be set to 1, that is, in a case where the restricted TWT TDLS traffic info present identifier bit is set to 1, the restricted TWT TDLS parameter info field includes the restricted TWT TDLS traffic info field.

In some examples, in embodiments of the present disclosure, the first identification information includes a restricted TWT TDLS TID bitmap field in the restricted TWT TDLS traffic info field.

In some examples, the restricted TWT TDLS TID bitmap field may be used to identify the low-latency traffic type transmitted between the TDLS devices via the TDLS link, within the SP of the R-TWT schedule.

In some examples, in embodiments of the present disclosure, the restricted TWT TDLS traffic info field further includes a restricted TWT TDLS TID bitmap valid identifier bit;
in which in a case where the restricted TWT TDLS TID bitmap valid identifier bit is set to a third parameter value, within the SP of the R-TWT schedule, a traffic type allowed to be transmitted between the TDLS devices via the TDLS link is the low-latency traffic identified by the first identification information (TWT TDLS TID bitmap field);

In a case where the restricted TWT TDLS TID bitmap valid identifier bit is set to a fourth parameter value, within the SP of the R-TWT schedule, all traffic types are allowed to be transmitted between the TDLS devices via the TDLS link.

In some examples, the restricted TWT TDLS TID bitmap valid identifier bit may be included in a restricted TWT TDLS traffic info control subfield in the restricted TWT TDLS traffic info field.

As an example, the third parameter value may be set to 1; that is, in a case where the restricted TWT TDLS TID bitmap valid identifier bit is set to 1, within the SP of the R-TWT schedule, the traffic type allowed to be transmitted between the TDLS devices via the TDLS link is the low-latency traffic identified by the first identification information (TWT TDLS TID bitmap field); and
in a case where the restricted TWT TDLS TID bitmap valid identifier bit is set to 0, within the SP of the R-TWT schedule, all traffic types are allowed to be transmitted between the TDLS devices via the TDLS link.

In some examples, in embodiments of the present disclosure, the method includes:
receiving a first TWT setup frame transmitted by the TDLS device,
in which a TWT request identifier information in the first TWT setup frame indicates that the first TWT setup frame is a TWT setup request; and the first TWT setup frame indicates that the TDLS device requests to become a member of the R-TWT schedule.

In some examples, the AP negotiates an R-TWT schedule by receiving and responding to a first TWT setup frame transmitted by the TDLS device 1 and the TDLS device 2.

As an example, the TWT request identifier information may be 1 or 0. For example, the TWT request identifier information in the first TWT setup frame transmitted by the STA1 or the STA2 to the AP is 1 to indicate a request to become a member of the R-TWT schedule; and the TWT request identifier information of the AP response is 0 to indicate that the TDLS device becomes a member of the R-TWT schedule.

In embodiments of the present disclosure, the AP determines and transmits a first radio frame; in which the first radio frame includes first identification information, the first identification information identifies a traffic type allowed to be transmitted between TDLS devices via a TDLS link within an SP of an R-TWT schedule, and the traffic type includes a low-latency traffic, realizing that an R-TWT SP is not only used for transmission of the low-latency traffic between an R-TWT schedule AP and an R-TWT schedule member STA, but also supports the R-TWT schedule member STA to perform the transmission of the low-latency traffic via the TDLS link during the TDLS R-TWT duration. Based on the R-TWT mechanism, the periodic target wake time mechanism may effectively guarantee the transmission of a deterministic low-latency traffic and improve the transmission efficiency of a low-latency communication traffic. In addition, based on the TDLS link, communication between STAs without AP is realized. This peer to peer (P2P) communication method does not need to pass through the access point for data transmission, avoids the latency caused by network congestion, reduces the energy consumption of terminal device, and improves the data transmission efficiency. Embodiments of the present disclosure provide a communication method to further improve the R-TWT mechanism and ensure the transmission of the low-latency traffic.

Referring to FIG. 6, embodiments of the present disclosure provide a communication method, in some examples, the method is applied to a TDLS device, and the method includes:
in step 601, a first radio frame is received, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule.

The traffic type includes a low-latency traffic.

In some examples, the TDLS device receives a first radio frame, obtains the first identification information included in the first radio frame, and determines a traffic type transmitted between the TDLS devices via the TDLS link through the first identification information. The traffic type includes the low-latency traffic.

In some examples, in embodiments of the present disclosure, the first radio frame includes a beacon frame or a probe response frame.

In some examples, in embodiments of the present disclosure, a broadcast TWT parameter set field of the TWT element in the first radio frame includes a restricted TWT info field;
the restricted TWT info field includes restricted TWT info control information;
the restricted TWT info control information includes a restricted TWT TDLS traffic info present identifier bit;
the restricted TWT info field includes a restricted TWT TDLS traffic info field; and the first identification information is carried in the restricted TWT TDLS traffic info field.

In some examples, in embodiments of the present disclosure, the restricted TWT TDLS traffic info present identifier bit is set to a first parameter value, and the first parameter value indicates that the restricted TWT info field includes the restricted TWT TDLS traffic info field.

In some examples, the restricted TWT TDLS traffic info present identifier bit is included in the TWT element of the first radio frame.

As an example, the first parameter value may be set to 1, that is, in a case where the restricted TWT TDLS traffic info present identifier bit is set to 1, the restricted TWT info field includes the restricted TWT TDLS traffic info field.

In some examples, in embodiments of the present disclosure, a broadcast TWT parameter set field of the TWT element in the first radio frame includes a restricted TWT info field;
the restricted TWT info field includes a restricted TWT TDLS parameter info field;
the restricted TWT TDLS parameter info control field of the restricted TWT TDLS parameter info field includes a restricted TWT TDLS traffic info present identifier bit;
the restricted TWT TDLS parameter info field includes a restricted TWT TDLS traffic info field; and
the first identification information is carried in the restricted TWT TDLS traffic info field.

In some examples, in embodiments of the present disclosure, the restricted TWT TDLS traffic info present identifier bit is set to a second parameter value, and the second parameter value indicates that the restricted TWT TDLS parameter info field includes the restricted TWT TDLS traffic info field.

In some examples, the restricted TWT TDLS traffic info present identifier bit is included in the TWT element of the first radio frame.

As an example, the second parameter value may be set to 1, that is, in a case where the restricted TWT TDLS traffic info present identifier bit is set to 1, the restricted TWT TDLS parameter info field includes the restricted TWT TDLS traffic info field.

In some examples, in embodiments of the present disclosure, the first identification information includes a restricted TWT TDLS TID bitmap field in the restricted TWT TDLS traffic info field.

In some examples, the restricted TWT TDLS TID bitmap field may be used to identify the low-latency traffic type transmitted between the TDLS devices via the TDLS link, within the SP of the R-TWT schedule.

In some examples, in embodiments of the present disclosure, the restricted TWT TDLS traffic info field further includes a restricted TWT TDLS TID bitmap valid identifier bit;
in which in a case where the restricted TWT TDLS TID bitmap valid identifier bit is set to a third parameter value, within the SP of the R-TWT schedule, a traffic type allowed to be transmitted between the TDLS devices via the TDLS link is the low-latency traffic identified by the first identification information (TWT TDLS TID bitmap field); and
in a case where the restricted TWT TDLS TID bitmap valid identifier bit is set to a fourth parameter value, within the SP of the R-TWT schedule, all traffic types are allowed to be transmitted between the TDLS devices via the TDLS link.

In some examples, the restricted TWT TDLS TID bitmap valid identifier bit may be included in a restricted TWT TDLS traffic info control field in a restricted TWT TDLS traffic info field.

As an example, the third parameter value may be set to 1, that is, in a case where the restricted TWT TDLS TID bitmap valid identifier bit is set to 1, the low-latency traffic type identified by the restricted TWT TDLS TID bitmap field is valid. The traffic type allowed to be transmitted between the TDLS devices via the TDLS link is the low-latency traffic identified by the TWT TDLS TID bitmap field, within the SP of the R-TWT schedule.

As an example, the fourth parameter value may be set to 0, that is, in a case where the restricted TWT TDLS TID bitmap valid identifier bit is set to 0, the low latency traffic type identified by the restricted TWT TDLS TID bitmap field is invalid. All traffic types are allowed to be transmitted between the TDLS devices via the TDLS link within the service period (SP) of the restricted target wake time (R-TWT) schedule.

In some examples, in embodiments of the present disclosure, the method includes:
transmitting a first TWT setup frame to an access point (AP), in which a TWT request identifier information of the first TWT setup frame indicates that the first TWT setup frame is a TWT setup request; and the first TWT setup frame indicates that the TDLS device requests to become a member of the R-TWT schedule; and
receiving a second TWT setup frame fed back by the AP, in which a TWT request identifier information of the second TWT setup frame indicates that the second TWT setup frame is a TWT setup response; and the second TWT setup frame is transmitted in response to the first TWT setup frame.

As an example, the TWT request identifier information may be 1 or 0. For example, the TWT request identifier information in the first TWT setup frame transmitted by the STA1 or the STA2 to the AP is 1, to indicate a request to become a member of the R-TWT schedule; the TWT request identifier information of 0 in the TWT setup frame responded by the AP indicates that the TWT setup frame is a TWT setup response, and instructs the AP to respond to the TWT setup request transmitted by the TDLS device.

In some examples, in embodiments of the present disclosure, after receiving the second TWT setup frame fed back by the AP, the method includes:
within the SP of the R-TWT schedule, transmitting traffic data via the TDLS link according to the traffic type identified by the first identification information.

In some examples, after the AP negotiates with the TDLS device that the TDLS device becomes a member of the R-TWT schedule, within the SP of the R-TWT schedule, the AP may transmit traffic data via the TDLS link according to the traffic type identified by the first identification information.

In some examples, in embodiments of the present disclosure, transmitting the traffic data via the TDLS link according to the traffic type identified by the first identification information includes:
in a case where the restricted TWT TDLS TID bitmap valid identifier bit is set to a third parameter value, transmitting thw low-latency traffic identified by the restricted TWT TDLS TID bitmap field via the TDLS link; or
in a case where the restricted TWT TDLS TID bitmap valid identifier bit is set to a fourth parameter value, transmitting traffic data of all traffic types via the TDLS link.

As an example, the third parameter value may be set to 1; that is, in a case where the restricted TWT TDLS TID bitmap valid identifier bit is set to 1, within the SP of the R-TWT schedule, the traffic type allowed to be transmitted between the TDLS devices via the TDLS link is the low-latency traffic identified by the first identification information (TWT TDLS TID bitmap field); and
the fourth parameter value may be set to 0; in a case where the restricted TWT TDLS TID bitmap valid identifier bit is set to 0, within the SP of the R-TWT schedule, traffic data of all traffic types are transmitted between the TDLS devices via the TDLS link.

In embodiments of the present disclosure, the R-TWT SP is not only used for low-latency traffic transmission between an R-TWT schedule AP and an R-TWT schedule member STA, but also supports the R-TWT schedule member STAs to perform low-latency traffic transmission via the TDLS link during the TDLS R-TWT duration. Based on the R-TWT mechanism, the periodic target wake time mechanism may effectively guarantee the transmission of a deterministic low-latency traffic and improve the transmission efficiency of a low-latency communication traffic. In addition, based on the TDLS link, communication between STAs without AP is realized. This peer to peer (P2P) communication method does not need to pass through the access point for data transmission, avoids the latency caused by network congestion, reduces the energy consumption of terminal device, and improves the data transmission efficiency. Embodiments of the present disclosure provide a communication method to further improve the R-TWT mechanism and ensure the transmission of a low-latency traffic.

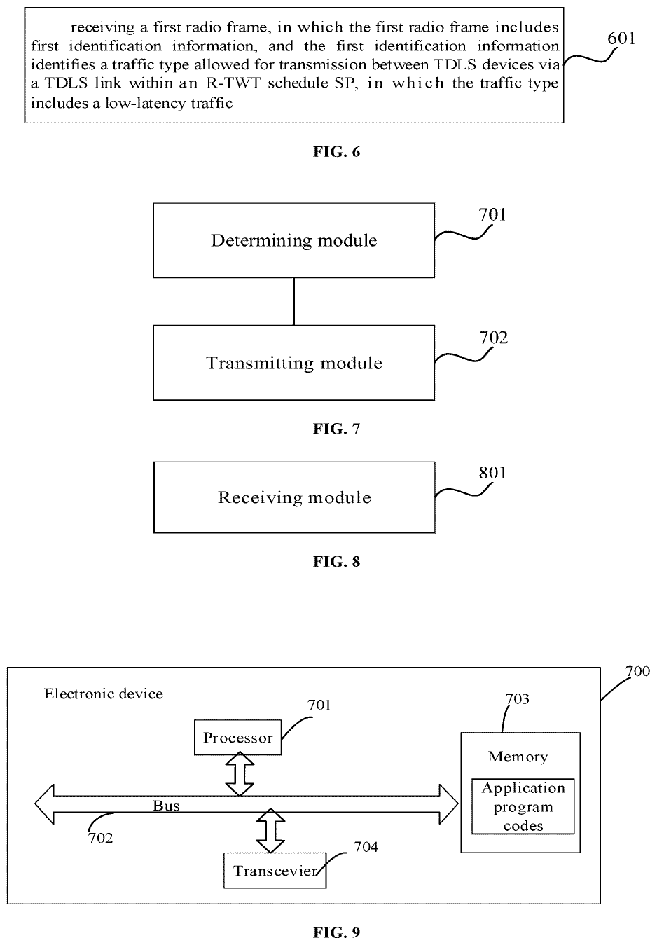

Referring to FIG. 7, based on the same principle as the method provided by the embodiment of the present disclosure, embodiments of the present disclosure further provide an electronic device, the electronic device is an access point (AP), and the electronic device includes:
a determining module 701 configured to determine a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which the traffic type includes a low-latency traffic; and
a transmitting module 702 configured to transmit the first radio frame.

Embodiments of the present disclosure further provide an apparatus for transmitting a low-latency traffic, and the apparatus is applied to an access point (AP) and includes:
a radio frame determining module configured to determine a first radio frame, in which the first radio frame includes first identification information, and the first identification information identifies a traffic type allowed to be transmitted between tunneled direct link setup (TDLS) devices via a TDLS link within a service period (SP) of a restricted target wake time (R-TWT) schedule, in which the traffic type includes a low-latency traffic; and
a radio frame transmitting module configured to transmit the first radio frame.

The apparatus also includes other modules of the electronic device in embodiments described above, which will not be described here.

Referring to FIG. 8, based on the same principle as the method provided by embodiments of the present disclosure, embodiments of the present disclosure further provide an electronic device, the electronic device is a TDLS device, and the electronic device includes:
a receiving module 801 configured to receive a first radio frame,
in which the first radio frame includes first identification information, and the first identification information identifies a traffic type allowed to be transmitted between TDLS devices via a TDLS link within an SP of an R-TWT schedule,
in which the traffic type includes a low-latency traffic.

Embodiments of the present disclosure also provide an apparatus for transmitting a low-latency traffic, and the apparatus is applied to a TDLS device and includes:
a radio frame receiving module configured to receive the first radio frame,
in which the first radio frame includes first identification information, and the first identification information identifies a traffic type allowed to be transmitted between TDLS devices via a TDLS link within an SP of an R-TWT schedule,
in which the traffic type includes a low-latency traffic.

The apparatus also includes other modules of the electronic device in the embodiments described above, which is not be described here.

In an optional embodiment, embodiments of the present disclosure further provide an electronic device, and as illustrated in FIG. 9, the electronic device 700 illustrated in FIG. 9 may be a server, and includes a processor 701 and a memory 703. The processor 701 and the memory 703 are connected, e.g., via the bus 702. In some examples, the electronic device 700 may also include a transceiver 704. It should be noted that the transceiver 704 is not limited to one in practical applications, and the structure of this electronic device 700 does not constitute a limitation of embodiments of the present disclosure.

The processor 701 may be a CPU (Central Processing Unit), a general purpose processor, a DSP (Digital Signal Processor), an ASIC (Application Specific Integrated Circuit), an FPGA (Field Programmable Gate Array) or other programmable logic device, a transistor logic device, a hardware component, or any combination thereof. It may implement or execute various illustrative logic blocks, modules, and circuits described in connection with the present disclosure. The processor 701 may also be a combination that implements computing functions, for example, including a combination of one or more microprocessor, a combination of a DSP and a microprocessor, and the like.

The bus 702 may include a pathway to transfer information between the above components. The bus 702 may be a PCI (Peripheral Component Interconnect) bus or an EISA (Extended Industry Standard Architecture) bus, etc. The bus 702 may be divided into address bus, data bus, control bus, etc. For ease of representation, only one thick line is illustrated in FIG. 9, but this does not indicate that there is only one bus or one type of bus.

The memory 703 may be read only memory (ROM) or other types of static storage devices capable of storing static information and instructions, random access memory (RAM) or other types of dynamic storage devices capable of storing information and instructions, or electrically erasable programmable read-only memory (EEPROM), compact disc read only memory (CD-ROM) or other optical disc storage, optical disc storage (including compressed discs, laser discs, optical discs, digital versatile discs, Blue-ray discs, etc.), disk storage media or other magnetic storage devices, or any other media capable of being used for carrying or storing desired program codes in the form of instructions or data structures and capable of being accessed by a computer, but the present disclosure is not limited to this.

The memory 703 is configured to store application program codes for executing embodiments of the present disclosure and is controlled for execution by the processor 701. The processor 701 is configured to execute application program codes stored in the memory 703 to implement the contents illustrated in the aforementioned method embodiments.

The electronic device includes, but is not limited to, mobile terminals such as a mobile phone, a notebook computer, a digital broadcast receiver, a PDA (Personal Digital Assistant), a PAD (Tablet Computer), a PMP (Portable Multimedia Player), a vehicle-mounted terminal (for example, a vehicle-mounted navigation terminal), and the like, and a fixed terminal such as a digital TV, a desktop computer, and the like. The electronic device illustrated in FIG. 8 is merely an example, and should not impose any limitation on the functions and scope of use of the embodiments of the present disclosure.

The server provided by the present disclosure may be an independent physical server, may be a server cluster or distributed system composed of a plurality of physical servers, or may be a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, a tablet computer, a notebook computer, a desktop computer, a smart speaker, a smart watch, but is not limited thereto. The terminal and the server may be directly or indirectly connected by wired or wireless communication, which is not limited by the present disclosure.

Embodiments of the present disclosure provide a computer-readable storage medium storing a computer program that, when run on a computer, causes the computer to execute the corresponding contents of the method embodiments described above.

It should be appreciated that although the individual steps in the flowchart of the accompanying drawings are illustrated sequentially as indicated by the arrows, the steps are not necessarily performed sequentially in the order indicated by the arrows. Unless expressly stated herein, the execution of these steps is not strictly limited in order, and they may be performed in any other order. Moreover, at least part of the steps in the flowchart of the accompanying drawings may include a plurality of sub-steps or a plurality of phases, these sub-steps or phases are not necessarily executed to completion at the same moment but may be executed at different moments, and the order of their execution is not necessarily sequential, but may be executed in turn or alternately with at least part of other steps or sub-steps or phases of other steps.

It should be noted that the computer-readable storage medium described above in the present disclosure may be a computer-readable signal medium or a computer-readable storage medium or any combination thereof. The computer-readable storage medium may, for example, be —but is not limited to—a system, apparatus, or device of electricity, magnetism, light, electromagnetism, infrared, or semiconductors, or a combination of any of the above. More specific examples of the computer readable medium include but are not limited to: an electronic connection with one or more wires, a portable computer disk, a hard disc, a random access memory (RAM), a read only memory (ROM), an erasable programmable read-only memory (EPROM or a flash memory), optical fiber, an optical storage device, a magnetic storage device, or any suitable combination of the above-mentioned. In the present disclosure, a computer-readable storage medium may be any tangible medium containing or storing a program, and the program may be used by or in combination with an instruction-executing system, apparatus, or device. In the present disclosure, the computer-readable signal medium may include a data signal propagated in a baseband or as part of a carrier, carrying computer-readable program codes. Such propagated data signals may take a variety of forms, including, but not limited to, electromagnetic signals, optical signals, or any suitable combination of the above-mentioned. The computer-readable signal medium may also be any computer-readable storage medium other than the computer-readable storage medium, and the computer-readable signal medium may send, propagate, or transmit a program for use by, or in conjunction with, an instruction-executing system, apparatus, or device. The program codes contained on the computer-readable storage medium may be transmitted using any suitable medium, including, but not limited to: wire, fiber optic cable, RF (radio frequency), or any suitable combination of the above mentioned.

The computer-readable storage medium may be contained in the electronic device; or it may stand alone and not be assembled into the electronic device.

The computer-readable storage medium carries one or more programs that, when the one or more programs are executed by the electronic device, cause the electronic device to execute the method illustrated by the embodiments described above.

According to an aspect of the present disclosure, there is provided a computer program product or computer program, the computer program product or computer program includes computer instructions, and the computer instructions are stored in a computer readable storage medium. The processor of the computer device reads the computer instructions from the computer-readable storage medium, and the processor executes the computer instructions such that the computer device performs the method provided in the various optional implementations described above.

Computer program code for performing the operations of the present disclosure may be written in one or more programming languages or combinations thereof, including object-oriented programming languages—such as Java, Smalltalk, C++—and conventional procedural programming languages-such as the ‘C’ language or similar programming languages. The program codes may be executed entirely on the user computer, partially on the user computer, as a stand-alone software package, partially on the user computer and partially on a remote computer, or entirely on a remote computer or server. In situations involving the remote computer, the remote computer may be connected to the user computer via any kind of network, including a local area network (LAN) or a wide area network (WAN), or it may be connected to an external computer (e.g., by using an Internet Service Provider (ISP) to connect via the Internet).

The flowcharts and block diagrams in the accompanying drawings illustrate the architecture, functionality, and operation capable of being implemented in accordance with systems, methods, and computer program products of various embodiments of the present disclosure. In this regard, each box in the flowchart or block diagram may represent a module, program segment, or portion of codes containing one or more executable instructions for implementing a specified logical function. It should also be noted that in some implementations as replacements, the functions indicated in the boxes may also occur in a different order than indicated in the accompanying drawings. For example, two consecutively represented boxes can actually be executed essentially in parallel, and they can sometimes be executed in reverse order, depending on the function involved. It should also be noted that each box in the block diagram and/or flowchart, and combinations of boxes in the block diagram and/or flowchart, may be implemented with a dedicated hardware-based system for performing the specified function or operation, or may be implemented with a combination of dedicated hardware and computer instructions.

The modules described and involved in embodiments of the present disclosure may be implemented by way of software or may be implemented by way of hardware. The name of the module does not in some cases constitute a limitation of the module itself, for example, module A may also be described as ‘module A for performing operation B’.

The above description is only preferred embodiments of the present disclosure and an illustration of the technical principles employed. It should be understood by those skilled in the art that the scope of the present disclosure involved in the present disclosure is not limited to a technical solution formed by a particular combination of the above technical features, but should also cover other technical solutions formed by any combination of the above technical features or their equivalent features without departing from the above concepts of the present disclosure. For example, the technical solution formed by interchanging the above features with (but not limited to) technical features with similar functions disclosed in the present disclosure.

1. A communication method, applied to an access point (AP), comprising:
determining a first radio frame, wherein the first radio frame comprises first identification information, and the first identification information identifies a traffic type allowed to be transmitted between tunneled direct link setup (TDLS) devices via a TDLS link within a service period (SP) of a restricted target wake time (R-TWT) schedule, wherein the traffic type comprises a low-latency traffic; and
transmitting the first radio frame.

2. The method according to claim 1, wherein a broadcast TWT parameter set field of a TWT element in the first radio frame comprises a restricted TWT info field;
the restricted TWT info field comprises restricted TWT info control information;
the restricted TWT info control information comprises a restricted TWT TDLS traffic info present identifier bit;
the restricted TWT info field comprises a restricted TWT TDLS traffic info field; and
the first identification information is carried in the restricted TWT TDLS traffic info field.

3. The method according to claim 2, wherein:
the restricted TWT TDLS traffic info present identifier bit is set to a first parameter value, and the first parameter value indicates that the restricted TWT info field comprises the Restricted TWT TDLS traffic info field.

4. The method according to claim 1, wherein:
a broadcast TWT parameter set field of a TWT element in the first radio frame comprises a restricted TWT info field;
the restricted TWT info field comprises a restricted TWT TDLS parameter info field;
a restricted TWT TDLS parameter info control field of the restricted TWT TDLS parameter info field comprises a restricted TWT TDLS traffic info present identifier bit;
the restricted TWT TDLS parameter info field comprises a restricted TWT TDLS traffic info field; and
the first identification information is carried in the restricted TWT TDLS traffic info field.

5. The method according to claim 4, wherein:
the restricted TWT TDLS traffic info present identifier bit is set to a second parameter value, and the second parameter value indicates that the restricted TWT TDLS parameter info field comprises the restricted TWT TDLS traffic info field.

6. The method according to claim 1, wherein the first identification information comprises a restricted TWT TDLS traffic identifier (TID) bitmap field.

7. The method according to claim 6, wherein a restricted TWT TDLS traffic info field further comprises a restricted TWT TDLS TID bitmap valid identifier bit,
wherein in a case where the restricted TWT TDLS TID bitmap valid identifier bit is set to a third parameter value, within the SP of the R-TWT schedule, the traffic type allowed to be transmitted between the TDLS devices via the TDLS link is the low-latency traffic identified by the first identification information; and
in a case where the restricted TWT TDLS TID bitmap valid identifier bit is set to a fourth parameter value, within the SP of the R-TWT schedule, all traffic types are allowed to be transmitted between the TDLS devices via the TDLS link.

8. The method according to claim 7, comprising:
receiving a first TWT setup frame transmitted by the TDLS device,
wherein a TWT request identifier information in the first TWT setup frame indicates that the first TWT setup frame is a TWT setup request; and the first TWT setup frame indicates that the TDLS device requests to become a member of the R-TWT schedule.

9. The method according to claim 8, wherein the first radio frame comprises a beacon frame or a probe response frame.

10. A communication method, applied to a tunneled direct link setup (TDLS) device, comprising:
receiving a first radio frame, wherein the first radio frame comprises first identification information, and the first identification information identifies a traffic type allowed to be transmitted between TDLS devices via a TDLS link within a service period (SP) of a restricted target wake time (R-TWT) schedule, wherein the traffic type comprises a low-latency traffic.

11. The method according to claim 10, wherein a broadcast TWT parameter set field of a TWT element in the first radio frame comprises a restricted TWT info field;
the restricted TWT info field comprises restricted TWT info control information;
the restricted TWT info control information comprises a restricted TWT TDLS traffic info present identifier bit;
the restricted TWT info field comprises a restricted TWT TDLS traffic info field; and
the first identification information is carried in the restricted TWT TDLS traffic info field.

12. The method according to claim 11, wherein:
the restricted TWT TDLS traffic info present identifier bit is set to a first parameter value, and the first parameter value indicates that the restricted TWT info field comprises the Restricted TWT TDLS traffic info field.

13. The method according to claim 10, wherein:
a broadcast TWT parameter set field of a TWT element in the first wireless frame comprises a restricted TWT info field;
the restricted TWT info field comprises a restricted TWT TDLS parameter info field;
a restricted TWT TDLS parameter info control field of the restricted TWT TDLS parameter info field comprises a restricted TWT TDLS traffic info present identifier bit;
the restricted TWT TDLS parameter info field comprises a restricted TWT TDLS traffic info field; and
the first identification information is carried in the restricted TWT TDLS traffic info field.

14. The method according to claim 13, wherein:
the restricted TWT TDLS traffic info present identifier bit is set to a second parameter value, and the second parameter value indicates that the restricted TWT TDLS parameter info field comprises the restricted TWT TDLS traffic info field.

15. The method according to claim 10, wherein the first identification information comprises a restricted TWT TDLS traffic identifier (TID) bitmap field; or wherein the first radio frame comprises a beacon frame or a probe response frame.

16. The method according to claim 15, wherein a restricted TWT TDLS traffic info field further comprises a restricted TWT TDLS TID bitmap valid identifier bit,
wherein in a case where the restricted TWT TDLS TID bitmap valid identifier bit is set to a third parameter value, within the SP of the R-TWT schedule, the traffic type allowed to be transmitted between the TDLS devices via the TDLS link is the low-latency traffic identified by the first identification information; and
in a case where the restricted TWT TDLS TID bitmap valid identifier bit is set to a fourth parameter value, within the SP of the R-TWT schedule, all traffic types are allowed to be transmitted between the TDLS devices via the TDLS link.

17. The method according to claim 16, comprising:
transmitting a first TWT setup frame to an access point (AP), wherein a TWT request identifier information of the first TWT setup frame indicates that the first TWT setup frame is a TWT setup request; and the first TWT setup frame indicates that the TDLS device requests to become a member of the R-TWT schedule; and
receiving a second TWT setup frame fed back by the AP, wherein a TWT request identifier information of the second TWT setup frame indicates that the second TWT setup frame is a TWT setup response; and the second TWT setup frame is transmitted in response to the first TWT setup frame.

18. The method according to claim 17, wherein after receiving the second TWT setup frame fed back by the AP, the method comprises:
within the SP of the R-TWT schedule, transmitting traffic data via the TDLS link according to the traffic type identified by the first identification information; and
wherein transmitting traffic data via the TDLS link according to the traffic type identified by the first identification information comprises:
in a case where the restricted TWT TDLS TID bitmap valid identifier bit is set to a third parameter value, transmitting the low-latency traffic identified by the restricted TWT TDLS TID bitmap field via the TDLS link; or
in a case where the restricted TWT TDLS TID bitmap valid identifier bit is set to a fourth parameter value, transmitting traffic data of all traffic types via the TDLS link.

19-22. (canceled)

23. An electronic device, comprising:
a processor; and
a memory storing a computer program executable by the processor,
wherein the processor is configured to determine a first radio frame, wherein the first radio frame comprises first identification information, and the first identification information identifies a traffic type allowed to be transmitted between tunneled direct link setup (TDLS) devices via a TDLS link within a service period (SP) of a restricted target wake time (R-TWT) schedule, wherein the traffic type comprises a low-latency traffic; and
transmit the first radio frame.

24. (canceled)

25. An electronic device, comprising:
a processor; and
a memory storing a computer program executable by the processor,
wherein the processor executes the program to implement the method according to claim 10.
